(19) United States
(12) Patent Application Publication
(10) Pub. No.: US 2011/0214325 A1
(43) Pub. Date: Sep. 8, 2011

(54) MULTI-DIMENSIONAL SHELF LABEL

(76) Inventor: Ronald DARRESS, Lynbrook, NY (US)

(21) Appl. No.: 13/040,567

(22) Filed: Mar. 4, 2011

Related U.S. Application Data
(60) Provisional application No. 61/310,826, filed on Mar. 5, 2010.

(51) Int. Cl. G09F 3/20; G09F 3/08

(52) U.S. Cl. 40/661.03

(57) ABSTRACT

An advertising display mounting device is provided for attaching promotional displays to a price channel mounted on the edge of a grocery or other retail store shelf. This mounting device is made from a flat piece of paper stock having score lines for folding. Die cuts that form clips when pushed out from mounting flaps of the device are adapted to mate with the price channel of the shelf. The device, when folded and mounted to the price channel has a center portion that extends outwards from the price channel. A die cut where the center portion meets the center portion causes a gap thereat, which enables the center portion to descend vertically from the price channel.

This application claims priority to provisional application 61/310,826, filed Mar. 5, 2010, which is incorporated herein by reference in its entirety.

### BACKGROUND OF THE INVENTION

In today's uncertain economy, the typical consumer arrives at the shopping center with a limited budget and a heightened need to obtain the products he or she wants at the best possible price. But when presented with a confusing array of similar items, the buyer often settles for a familiar brand or appealing packaging that indeed may not offer the best price point or quantity for a certain price. More sophisticated methods designed to successfully attract the consumer to promotional items in the store environment have become necessary to maximize customer awareness, enhance buyer satisfaction and increase profitability.

For many years, stores have used “shelf-talkers”, a special type of product label designed for promoting special sale pricing or promotions. It is typically larger than the permanent shelf label and is affixed, either by a pressure-sensitive label or a die-cut, or a combination of the two means of attachment, to the C-shaped metal bracket extending along the front edge of the shelf where the corresponding product is displayed.

Shelf-talkers are typically provided in groups of similar size on individual sheets for ease of printability. Fixed information, such as store name and product graphics, may be pre-printed in large quantities on the sheets in any suitable manner during the production of the shelf-talkers. Variable information, such as the specific product, size, and promotional price, may then be locally printed on each sheet using a suitable printer.

A typical shelf-talker is manufactured of card stock which is relatively inexpensive, is easily printed, and is sufficiently stiff for preventing undesirable curling when temporarily mounted to the shelf bracket. Mounting is typically accomplished by providing a central die-cut tab of the card which permits the bottom of the tab and the top of the card to be trapped in corresponding top and bottom channel of the shelf price channel bracket. In this way, the shelf-talker is mechanically retained in the shelf price channel bracket, which is sufficient for its limited duration use.

However, the shelf-talkers can be inadvertently removed from the shelf or slid along when hit by a customer. This problem has been solved by using full label sheet shelf-talkers which have also enjoyed years of successful commercial use in this country. This type of shelf-talker includes a label sheet adhesively bonded to a release liner so that the top portion of the liner may be removed for adhesively bonding the top of the label to the shelf bracket. The typical adhesive provides a temporary bond with the bracket so that the label may be removed when desired. The adhesive also prevents inadvertent removal or sliding of the label on the bracket.

When affixed to the shelf, the shelf-talker can be easily viewed by a customer who is seeking out a certain item and is interested in making an informed price comparison within that specific product group. Existing shelf-talkers, which are one dimensional, are limited by the fact that they can only be read when the customer is already looking straight ahead at a product group.

When today's cost-conscious customer is seeking out bargains throughout the store, instead of shopping for a specific item, the existing type of shelf-talker does not have the ability to draw their attention at a distance from promotional products.

### BRIEF SUMMARY OF THE DISCLOSURE

The multidimensional shelf label is made from a flat piece of paper having a center portion and two mounting flap portions. A plurality of score lines on the flat piece of paper define folding locations such that when folded along the score lines cause the center portion to extend outwardly from the mounting flap portions. The mounting flap portions each have a die-cut forming a mounting clip that fits into a C-channel of a shelf price channel. The die-cut on the mounting flap has a curved portion at each end to provide stress relief when the die-cut is formed into the mounting clip.

In one embodiment, first score lines of the plurality of score lines on the flat piece of paper define a folding location between the mounting flap portions and the center portion and a second score line of the plurality of score lines on the flat piece of paper defines a folding location on the center portion and is substantially in the center of the center portion. In another embodiment, the first score lines are partially cut to separate a portion of the mounting flap from the center portion and cause a gap to be formed between a portion of the mounting flap potion and the center portion when the shelf label is folded along the first score lines.

The present disclosure provides a multidimensional shelf label for a customer to be able to spot promotional opportunities from both directions, up and down a store aisle. A multi-dimensional adaptation of the shelf-talker, as proposed in this application, has a feature that the shelf-talker may be viewed any angle. Two front-facing flat panels on the left and right sides of an obtrusive central folded panel can be seen from both directions of the promotional item. This feature has a benefit of attracting customers from both directions in the store aisle as well as from straight ahead. Customer will be able to look down an aisle and see a variety of products advertised. Knowing that this type of label is designed to promote a special sale or promotion, customers may be enticed to investigate that product, even it was not on their original shopping list.

Another feature of the multi-dimensional shelf-talker of the present disclosure is that customers can see the promotional material as they approach the product on the shelf from the side, not only when facing the product. Multi-dimensional shelf-talkers can increase sales of promotional items that customers were planning to buy by alerting the customer to the product location and promotional material, but also grow profitability of other product areas as well as introduce customers to new items by alerting customers to products they might otherwise pass by without noticing.

### BRIEF SUMMARY OF THE DRAWINGS

FIG. 1—illustrates the present invention having a portion descending below the mounting portion;

FIG. 2—illustrates another embodiment of the present invention;

FIG. 3—illustrates another embodiment of the present invention having a shaped protruding portion such as a square, star, octagon, heart, triangle, rectangle etc.

FIG. 4—illustrates another embodiment of the present invention wherein the protruding portion is extended;

FIG. 5—illustrates another embodiment of the present invention; and

FIG. 6A-6D—illustrate an assembly of the invention illustrated in FIG. 1.

### DETAILED DESCRIPTION

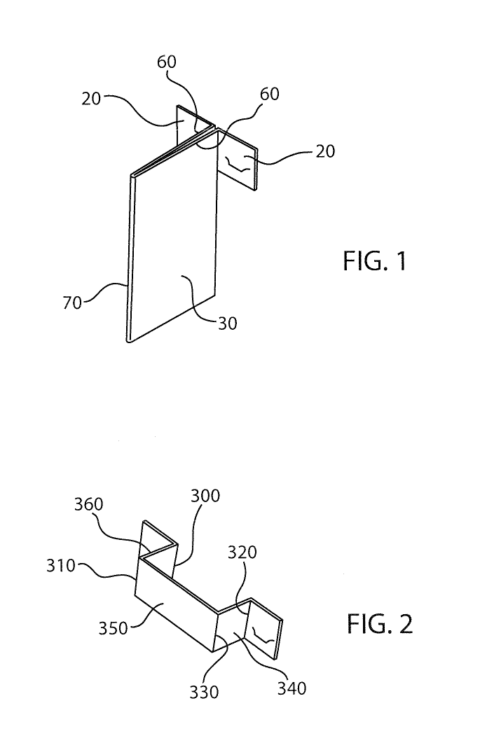

The multi-dimensional shelf-talker is available in several configurations. FIGS. 1-5 illustrate a few examples that are easily manufactured on printable card stock, scored for easy folding and equipped with a die-cut as well as adhesive or glue dots for attachment to the shelf lip.

In addition to its unique ability to draw customers to a promotional item from a distance in the store environment, the multi-dimensional shelf-talker features an improved die-cut with a release (see arrow in FIG. 1), which will enhance ease of application, accommodate shelf lips of varying sizes and aids in quick removability.

The following diagrams will illustrate some of the various available configurations of the multi-dimensional shelf-talker. Additionally, it will depict the method of manufacture and the simple means of scoring and folding. While certain features are described as “descending” it is to be understood the feature could be “ascending” without detracting from the inventive concept.

FIG. 1 illustrates an embodiment having score lines 60, 70 such that, when folded, the shelf-talker has a triangular descending portion 30 that protrudes substantially perpendicularly from mounting flaps 20, and two surfaces of the triangular portion can have promotional and informational text. FIG. A is an illustrative example described in more detail below.

FIG. 2 illustrates an embodiment having score lines 300, 310, 320, 330 such that, when folded, the shelf-talker exhibits three sides 340, 350, 360 that protrude from the mounting flaps for promotional and informational text. As illustrated, FIG. B does not have a descending portion as in FIG. A, but a descending portion may be added.

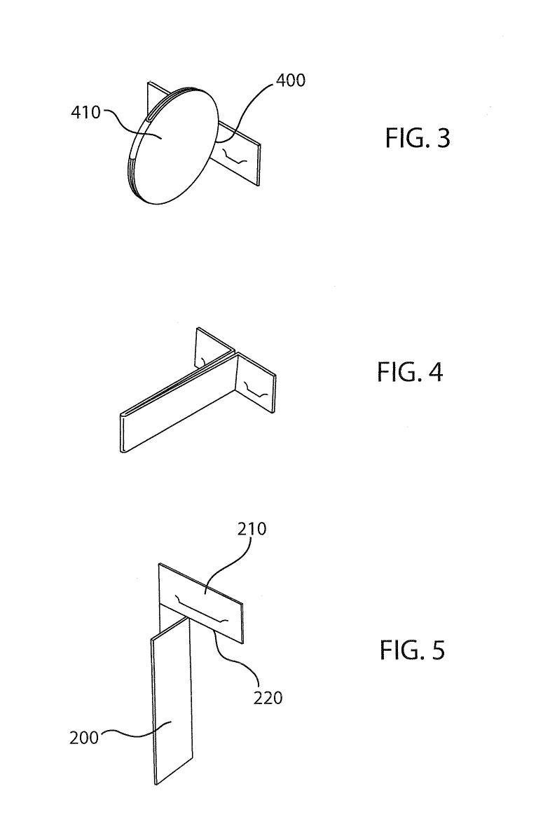

FIG. 3 illustrates an embodiment having a score line 400 such that when folded, the shelf-talker has an ornamental shape portion as discussed above for promotional and informational text and that protrudes substantially perpendicularly from the mounting flaps. In this embodiment, it may be advantageous to provide promotional or informational text on both sides of the shelf-talker so that, when folded, the text is visible on both sides of the ornamental shape.

FIG. 4 is similar to FIG. 1 but the triangular portion does not descend lower than the mounting flaps.

FIG. 5 illustrates an embodiment of the present invention in which a die-cut 220 is provided so a portion of the shelf-talker can be folded to form a flag portion 200 substantially perpendicular to a mounting 210. In this embodiment, it may be advantageous to provide promotional or informational text on both sides of the shelf-talker so that, when folded, the text is visible on both sides of the flag portion.

Multi-dimensional shelf-talkers of the present application are designed to be more visible than prior art designs. In one aspect of the disclosure, score lines are provided on a flat, two-dimensional shelf-talker. The shelf-talker is folded along the score lines to create a three-dimensional shape. When the multidimensional shelf label is mounted on a price channel of a shelf, a portion of the shelf-talker extends horizontally from the shelf due to the folding along the score lines.

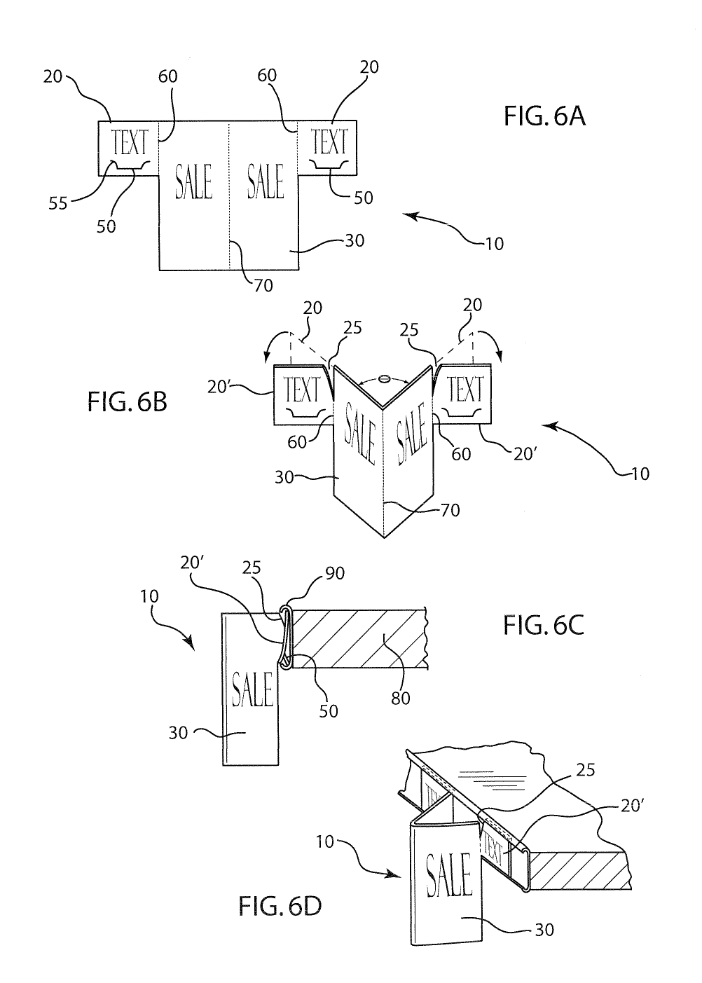

FIGS. 6A-6D illustrates the Multi-dimensional shelf-talker 10 of FIG. 1, which can be made from a flat sheet of printing stock. Other shelf-talkers of the present application can be adapted from this description. The printing stock should be sturdy enough to withstand minor jostling that may occur during usage. The shelf-talker includes one or more flaps 20 and can include a contiguous descending portion 30 that will descend lower than the shelf when mounted as described later. Both the flaps and descending portion can have promotional or other informational text thereon. It is not necessary for flaps 20 to be the same size. In an implementation, the shelf-talker can be arranged to have the center descending portion 30 rise above the shelf when mounted thereon without detracting from the inventive feature of the present application.

Each of the flaps 20 includes a die-cut tab 50. The die-cut tab 50 can have a safety release 55 in the shape of an arc that can provide stress relief to reduce tearing of the shelf-talker when the die-cut tab is pushed out. The die-cut tab safety release arc 55 can be extended to provide for the variability of dimensions of C-channels of shelves.

A score line 60 is provided where the flap 20 meets the descending portion 30. A portion of score line 60, less than the entire length of the score line, can be die-cut to provide a separation or gap between a portion of flaps 20 and center descending portion 30. A score line 70 is provided substantially in the middle of the center descending portion 30, although it is not necessary for score line 70 to be centered as illustrated.

FIG. 6B illustrates the Multi-dimensional shelf-talker of FIG. 6A folded to create a three-dimensional shape. Descending portion 30 is folded along score line 70 to an angle θ. Angle θ can be any desired angle from substantially 0 degrees to 180 degrees depending on the desired protrusion and angle the descending portion will present to a viewer when mounted to a shelf. Flaps 20 are folded in the direction shown by the arrow along score lines 60 to position flaps 20′. A gap 25 is formed when score line 60 has a partial separation of flaps 20′ from center descending portion 30.

FIG. 6C illustrates a side view of a shelf 80 having mounted thereon the Multi-dimensional shelf-talker of FIG. 6A folded as in FIG. 6B. In the mounting illustrated, shelf 80 has a price channel that is a C-shaped mounting bracket 90. Die-cut tab 50 is pushed out from flap 20′ and fitted into C-shaped mounting bracket 90 to hold the shelf-talker therein. When score line 60 has a partial separation of flaps 20′ from center descending portion 30, the gap 25 can aid in causing the descending center portion 30 to hang more vertically than without the gap 25. Other mountings are possible without detracting from the present design. For example, flaps 20′ can be mounted to a shelf not having a mounting bracket by adhesive, not using the die-cut tabs. When mounted, descending portion 30 extends horizontally from shelf 80.

FIG. 6D illustrates a perspective view of the Multi-dimensional shelf-talker mounted as in FIG. 6C. As shown, the folded center descending portion 30 extends horizontally from shelf 80 so the promotional or informational text is visible from the side of the shelf. Gap 25 can provide for the descending portion to hang more vertically than when there is not gap between the center descending portion and the flaps 20′. In this way, a consumer coming down an aisle can see the promotional or informational text without having to be directly in front of the shelf-talker.

Other embodiments are within the scope of the following claims.

I claim:

1. A multidimensional shelf label, comprising:
a flat piece of paper having a center portion and two mounting flap portions;
a plurality of score lines on the flat piece of paper that define folding locations such that when folded along the score lines cause the center portion to extend outwardly from the mounting flap portions;
a die-cut in each of the mounting flap portions, the die cut forming a mounting clip that fits into a C-channel of a shelf price channel,
wherein the die-cut has a curved portion at each end to provide stress relief when the die-cut is formed into the mounting clip.

2. The multidimensional shelf label of claim 1,
wherein first score lines of the plurality of score lines on the flat piece of paper define a folding location between the mounting flap portions and the center portion, and
wherein a second score line of the plurality of score lines on the flat piece of paper defines a folding location on the center portion and is substantially in the center of the center portion.

3. The multidimensional shelf label of claim 3, wherein the first score lines are partially cut to separate a portion of the mounting flap from the center portion and cause a gap to be formed between a portion of the mounting flap portion and the center portion when the shelf label is folded along the first score lines.

4. The multidimensional shelf label of claim 4, wherein text and graphics are displayed on the mounting flaps and center portion.

5. The multidimensional shelf label of claim 3, wherein the shape of the center portion is a rectangle.

6. The multidimensional shelf label of claim 5, wherein the center portion extends below the mounting flaps when the shelf label is folded.

7. The multidimensional shelf label of claim 5, wherein the center portion extends above the mounting flaps when the shelf label is folded.

8. The multidimensional shelf label of claim 3, wherein the shape of the center portion is selected from the group consisting of (star, circle and oval).

9. The multidimensional shelf label of claim 1,
wherein first score lines of the plurality of score lines on the flat piece of paper define a folding location between the mounting flap portions and the center portion, and
wherein plurality of second score lines of the plurality of score lines on the flat piece define a folding location on the center portion.

10. The multidimensional shelf label of claim 9, wherein the center portion forms a three-sided box when folded along the first and second score lines.
